(19) United States
(12) Patent Application Publication
(10) Pub. No.: US 2014/0317010 A1
(43) Pub. Date: Oct. 23, 2014

(54) PRIVACY AUCTION MECHANISM

(71) Applicant: THOMSON LICENSING, Issy de Moulineaux (FR)

(72) Inventors: Efstratios Ioannidis, Palo Alto, CA (US); Nada Fawaz, Santa Clara, CA (US); Pranav Dandekar, Stanford, CA (US)

(21) Appl. No.: 14/353,623

(22) PCT Filed: Oct. 9, 2012
(86) PCT No.: PCT/US2012/059302

§ 371 Date: Apr. 23, 2014

Related U.S. Application Data
(60) Provisional application No. 61/628,655, filed on Nov. 2, 2011.

(51) Int. Cl. G06Q 50/26; G06Q 30/00

(52) U.S. Cl. CPC G06Q 50/265; G06Q 30/01
USPC 705/325

(57) ABSTRACT

A consumer electronic device hosts a media application that obtains media content use data for a user. The media application interfaces with a server that analyzes the media content use-related data based on a budget-constrained DCLEF and/or a distortion-constrained DCLEF mechanism. The user is then compensated for their disclosed use data based on the severity of the privacy incursion.

### BACKGROUND

A statistic is differentially private if a third party viewing the statistic cannot determine if a user is in a database from which the statistic was derived. This can be used to quantify the privacy violation. The bigger the confidence that a third party can identify a user based on the release statistic the bigger the violation. Conversely, the smaller the confidence that a third party can identify a user based on the release statistic, the smaller the violation.

A user may consent to allow statistical data to be released that is partially based on data collected about the user (e.g., viewing habits). In return, the user may receive compensation (e.g., money, discounts, free movie rentals, free movie purchases, ad free service, etc.) from the data analyst releasing the statistical data. However, the data analyst needs to determine how much to compensate the user. One approach to compensation could be to compensate the user based on the size of the violation. The larger the user perceives the violation to be the greater the compensation. So the final compensation to a user is, for example, the money the user receives minus the cost of the violation.

Ghosh and Roth (Arpita Ghosh and Aaron Roth, Selling privacy at auction, In Proceedings of the 12^{th} ACM conference on Electronic commerce, EC'11, pages 199-208, new York, N.Y. USA, 20122, ACM, doi—http://doi.acm.org/10.1145/1993574.1993605) consider a database that only contains bits of ones and zeroes that simply represents whether a user in that database has, for example, watched a movie or not, has cancer or not, etc. The statistic that is derived and released from the database is the sum of the bits. For example, the number of users that have watched a movie or the number of users that don't have cancer. Ghosh and Roth then designed an auction mechanism that allows a data analyst to determine what users' privacy will be violated and how much each user will be compensated.

The data analyst starts off with a set amount of compensation that cannot be exceeded when paying the users for the privacy violations. The amount of compensation that the users get is more than the privacy violation cost. Therefore, if a user is given a lot of differential privacy then a low amount of compensation is given to the user. Alternatively, if a little amount of differential privacy is given to the user, a larger amount of compensation is provided. It should be noted that noise is added to the statistical data provided by the data analyst so the final output is more like an estimate of the statistic rather than the statistic purely based on user data. Of course, for the statistical data to be useful, it is best to have as close an estimate to the actual value as possible. Therefore, staying within a budget, properly incentivizing users and having the estimate be as close as possible to the actual statistical data are key aspects to the Ghosh and Roth mechanism.

In order to decide how to compensate the users, Ghosh and Roth ask each user how much the user values his/her privacy. For example, if your privacy is violated X amount, how much is that worth? So the users disclose the value they associate with their privacy, and based on this information the data analyst can determine which users to pay for privacy violations, how many users to include, etc. There is also an aspect of truthfulness in the Ghosh and Roth mechanism. More specifically, if every user accurately reports how much they value their privacy, any given user has no incentive to misrepresent how much he values his privacy. If a user overstates the value of his privacy, his data will not be used. If a user understates the value of his privacy, he will not be fully compensated.

### SUMMARY

A mechanism to incentivize users to share their private data when the private data is weighted differently depending on a desired statistic. In a weighted sum environment within a fixed budget, accuracy can be estimated using a budget and/or distortion-constrained DCLEF (Discrete Canonical Laplace Estimator Function) mechanism. The budget-constrained DCLEF and distortion-constrained DCLEF mechanisms can be implemented in a server or computer associated with a database of collected user data. This permits users to be compensated appropriately for the amount of privacy they have given up.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a network system employing an embodiment.

FIG. 2 is a flow diagram of a method of analyzing user data.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

Although the Ghosh and Roth mechanism/algorithm is a good approach for determining compensation for privacy violation, it is based on a sum of bits. The sum of bits approach is useful when all bits in a database are equally valuable. For example, when the data analyst wants to determine the amount of users that have watched a movie. However, in other scenarios where not all bits in the database are equally valuable the sum of bits approach is not useful. For example, when the data analyst wants to determine how many women between the ages of 20-29 liked a movie. In this case the bits representing women between the ages of 20-29 should be weighted higher than the bits for other users in the database (i.e., weighted sums should be used). In other words, a drawback to using the sum of all bits approach is that it is not particularly useful when not all bits in a database are equally important for a desired statistic. Moreover, the data stored in the data base need not necessarily consist of bits, but instead may include continuous data.

The present invention has properties of staying within a budget, properly incentivizing users, having the estimate be as close as possible to the actual statistical data, and truthfulness of the users valuation of their privacy. In addition to these properties, the present invention covers the use of weighted sums of arbitrary values, not necessarily restricted to bits. More specifically, in a weighted sum environment the present invention is directed at the following—within a fixed budget how accurate can an estimate be made using the Budget-constrained DCLEF (Discrete Canonical Laplace Estimator Function) mechanism.

Potential users include any entity that collects user data and desires to release statistical data. Therefore, potential users could include media content service providers and the like. The Budget-constrained DCLEF and Distortion-constrained DCI.FF mechanisms can be implemented in a server or computer associated with a database of collected user data. Initially (e.g., upon joining a media content service) and/or periodically (e.g., every month or every X times the user accesses the a media content service) a user can be asked how much compensation the user wishes to receive if the user's data (e.g., movie recommendations, viewing habits, etc.) is used to generate statistical data that can be released to the public and/or to a third party (e.g., a movie studio). Again, the compensation can be money in which case the user can be presented with a range of values (e.g., $1, $2 . . . $20) to choose from. Alternatively, the compensation can be free movie previews, movie discounts, reduced movie rentals, free movie rentals, and/or reduced movie purchase prices to free movie purchases and the like.

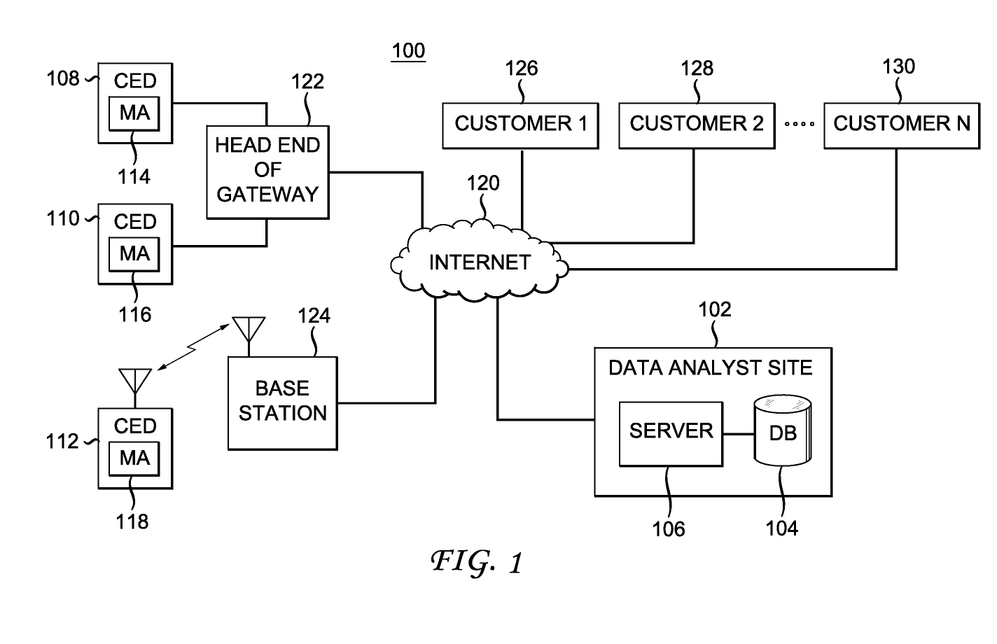

FIG. 1 illustrates one exemplary network 100 in which the mechanisms described herein can be used. In the network 100 there is a data analyst site 102 (e.g., media content provider services, etc.) that includes a database 104 (“DB”) for storing user data and a server 106 that contains the Budget-constrained DCLEF and/or Distortion-constrained DCLEF Mechanisms. A plurality of consumer electronic devices 108-112 (“CED”) containing media applications 114-118 (“MA”) are provided. The CEDs 108-112 can include, but are not limited to, televisions, set top boxes, computers, phones, personal digital assistants, tablets, etc. The MAs 114-118 can be, but are not limited to, media applications that recommend, for example, movies to users and allow the users to consume selected movies.

The MAs 114-118 collect user data (e.g., viewing habits, user ratings, etc.) and transfer the user data to the data analyst site 102 via, for example a wide area network (WAN) 120 such as the Internet. Wired MAs 114, 116 can access a WAN through, for example, a headend or gateway 122 and wireless CEDs 118 can access a WAN via, for example, base stations or hot spots 124. After compensating the users using the teachings herein, the data analyst site 102 can generate statistical data based on the collected user data and provide the statistical data to various customers (e.g., customers 1-N, 126-130). Exemplary customers can include movie studios, retail stores, etc. It should be noted that the present invention can be used on any type of weighted data environments and is not limited to media recommendation data or viewing habits data, etc.

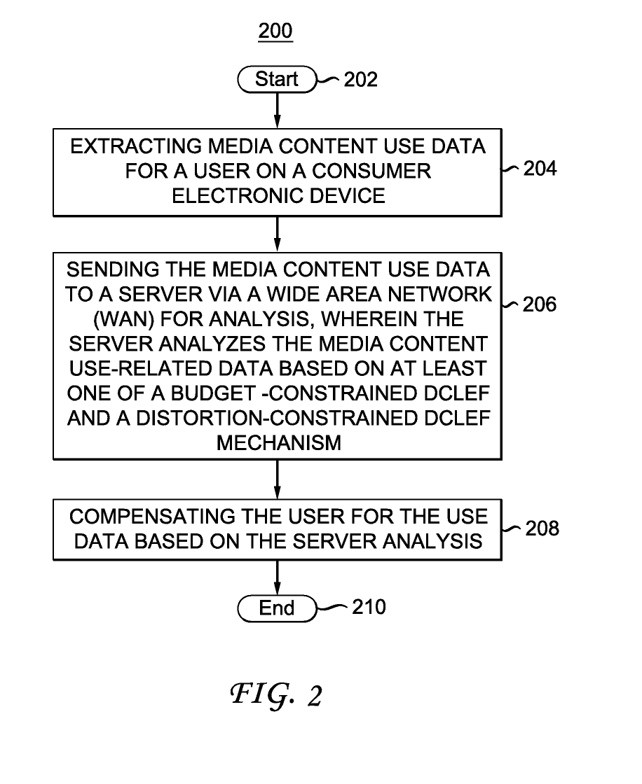

In view of the exemplary systems shown and described above, methodologies that can be implemented in accordance with the embodiments will be better appreciated with reference to the flow charts of FIG. 2. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 2 is a flow diagram of a method 200 of analyzing user data. The method starts 202 by extracting media content use data for a user on a consumer electronic device 204. This can include data extracted directly and/or indirectly from a user. For example, the user data can be obtained by a media application residing on the consumer electronic device that passively monitors a user's choices, habits and other data. The media application can also actively solicit feedback from the user to gather data. This can include audible and/or visual questions to illicit an active response from the user such as drop down menus, etc. displayed over media content and the like. The media content use data is then sent to a server via a wide area network (WAN) for analysis. The connection between the media application and the server can be via a wired and/or wireless connection and the like. Once the server obtains the data from the media application/consumer electronic device, it analyzes the media content use-related data based on a budget-constrained DCLEF and/or a distortion-constrained DCLEF mechanism 206. The user is then compensated for the use data based on the server analysis 208, ending the flow 210. The server can then produce statistical data to provide to consumers of such data such as media content creators (e.g. movie studios), a media content retail stores and a media content providers and the like.

The techniques for procuring and compensating the user for their information is based on a market for private data in which a data analyst wishes to publicly release a statistic computed over a database of private information. The statistic focuses on the inner product of the database entries with a publicly known weight vector. Users that own the data incur a cost for their loss of privacy quantified in terms of the differential-privacy guarantee given by the analyzer at the time of the release. To properly incentivize users, the analyzer must compensate them for the cost they incur. This gives rise to a privacy auction, in which the analyst decides how much privacy to purchase from each user, in order to cheaply obtain an accurate estimate of the inner product. The users are profit-maximizing, so a truthful auction is desired.

First, the trade-off between privacy and accuracy is formalized in this setting; we show that obtaining an accurate estimate of the inner product necessitates providing poor privacy guarantees to individuals that have a significant effect on the estimate. A simple, natural class of estimates achieves an order-optimal trade-off between privacy and accuracy. These estimates guarantee privacy to individuals in proportion to their effect on the accuracy of the estimate. This observation is used to design a truthful, individually rational, proportional-purchase mechanism under the constraint that the analyzer has a fixed budget. The mechanism disclosed herein is 5—approximate in terms of accuracy compared to the optimal mechanism, and that no truthful mechanism can achieve a 2—ε approximation, for any ε>0.

Informally, given ε>0, a randomized function over a database is ε-differentially private if changing a single entry of the database—corresponding to the data of a single individual—alters the probability of the function output by at most an e^{ε} factor. The parameter e captures the extent to which an individual's privacy is violated by the public release of the function's output; a small e corresponds to better privacy since it guarantees that the output is essentially independent of any single entry. Moreover, a guarantee of ε-differential privacy has a natural interpretation in terms of utility. In particular, Ghosh and Roth consider an individual with an arbitrary utility function over arbitrary future events. They show that an ε-differentially private release of a statistic based on the individual's data decreases the individual's future expected utility at most by a factor proportional to ε. This connection between differential privacy and utility motivates an economic approach to privacy, whereby an individual incurs a cost c(ε) because of an &differentially private release of his data and expects to be compensated for it.

Ghosh and Roth follow this approach to initiate the study of privacy auctions. In such auctions, a data analyst has access to a database d of private data dᵢ, i=1, . . . , n, each corresponding to a different individual. The analyst wishes to publicly release an accurate estimate ŝ(d) of a statistic s(d) evaluated over the database. The analyst has a budget, which limits the total compensation that can be paid out. If the estimate ŝ(d) provides an εᵢ-differential privacy guarantee to individual i, the latter incurs a cost cᵢ(εᵢ) and must be compensated by the analyst for this loss of utility. Further, the individuals' cost functions cᵢ(ε) are a priori unknown to the analyst, and the individuals are profit-maximizing. There is a natural trade-off between the accuracy of the release and the privacy loss of individuals. Releasing ŝ(d)=s(d) maximizes accuracy while minimizing privacy, while releasing random noise, or a constant that is independent of d, as the estimate accomplishes the opposite. Therefore, the analyst must (a) solicit the cost functions of individuals and (b) determine how much privacy to purchase from them, in order to obtain an accurate estimate while also not exceeding the budget.

Such a privacy auction is now considered in the case where the statistic s is an inner product, i.e., s(d):=<w,d>=Σᵢ₌₁ⁿ wᵢdᵢ, where w,d ε [symbol] ⁿ, and w is a publicly known weight vector. Interpreted as a “weighted average” of the private data dᵢ, the inner product is also interesting because it is one of the simplest statistics that exhibits asymmetry. Intuitively, as private entries dᵢ contribute to s(d) with different weights, they are not equally valuable to the analyst; the privacy auction needs to account for this when compensating individuals.

The accuracy of the estimate ŝ is characterized in terms of the distortion between the inner product s and ŝ defined as δ(s,ŝ):=max_{d} [symbol] [|s(d)−ŝ(d)|²], i.e., the maximum expected squared distance between s(d) and ŝ(d) over all databases d. A lower distortion corresponds to better accuracy. Interpreted as a worst-case mean square error, δ(s,ŝ) is a natural metric to consider. Moreover, when ŝ is a Laplace estimator (i.e., ŝ uses noise drawn from a Laplace distribution to guarantee privacy), a simple characterization of the distortion is obtained that converts the problem of minimizing distortion to one that resembles the knapsack problem. This relationship to knapsack makes Laplace estimators appealing, and the problem tractable.

However, in order to justify designing a privacy auction that outputs a Laplace estimator, we must argue that among all possible estimators of the inner product, focusing on Laplace estimators suffices. This is accomplished by defining a privacy index β(ŝ) that captures the amount of privacy an estimator ŝ provides to individuals in the database. The notion of privacy index allows us to show that (a) any estimator ŝ with low distortion must also have a low privacy index and, necessarily, violate the privacy of a set of individuals with a sufficiently high weight and (b) a special class of Laplace estimators, which we call Discrete Canonical Laplace Estimator Functions (DCLEF), exhibit an order-optimal trade-off between privacy and distortion. This allows us to focus on privacy auctions that output DCLEFs as estimators of the inner product s.

Due to the aforementioned relationship to knapsack, the problem of designing a privacy auction that outputs a DCLEF is similar in spirit to the knapsack auction mechanism designed by Singer (Yaron Singer, Budget feasible mechanisms, k In Proceedings of the 2010 IEEE 51st Annual Symposium on Foundations of Computer Science, FOCS'10, pages 765-774, Washington, D.C., USA, 2010. IEEE Computer Society, http://dx.doi.org/10.1109/FOCS.2010.78). However, this instance setting poses an additional challenge because costs exhibit externalities: the cost incurred by an individual in our setting is a function of which other individuals are being compensated. Despite the added complexity, we are able to design a truthful, individually rational, and budget feasible mechanism that outputs a DCLEF as an estimator of the inner product. Our estimator's accuracy is a 5-approximation with respect to the DCLEF output by an optimal, individually rational, budget feasible mechanism. This approximation ratio is noteworthy for two reasons: (a) despite the externalities in costs, we achieve the same approximation that Singer does for the knapsack mechanism, and (b) the approximation ratio is independent of input parameters, such as the size of the domain in which the database entries dᵢ take values. We also have a lower bound: there is no truthful DCLEF mechanism that achieves an approximation ratio 2−ε, for any ε>0.

A truthful, individually rational, budget-feasible DCLEF mechanism (i.e., a mechanism that outputs a DCLEF) is provided that it is 5-approximate in terms of accuracy compared with the optimal, individually rational, budget-feasible DCLEF mechanism. Note that a DCLEF is fully determined by the parameters x ε {0,1}ⁿ. Therefore, the output of the DCLEF mechanisms described below is referred to as (x, p), as the latter characterize the released estimator and the compensations to individuals.

Consider the problem of designing a DCLEF mechanism M that is individually rational and budget feasible (but not necessarily truthful), and minimizes δ_{M}. Given a DCLEF ŝ, define H(ŝ):={i:xᵢ=1} to be the set of individuals that receive non-zero differential privacy guarantees.

$$δ ( s , \hat{s} ) = \frac{9}{4} {{Δ}^{2} ( {\sum }_{i = 1}^{n} \vert {w}_{i} \vert ( 1 - {x}_{i} ) )}^{2} = \frac{9}{4} {{Δ}^{2} ( W - {\sum }_{i = 1}^{n} \vert {w}_{i} \vert {x}_{i} )}^{2} . \qquad ( Eq . 1 )$$

Eq. (1) implies that δ(s,ŝ)= 9/4Δ²(W−w(H(ŝ)))². Thus, minimizing δ(s,ŝ) is equivalent to maximizing w(H(ŝ)).

Let (xₒₚₜ,pₒₚₜ) be an optimal solution to the following problem:

$$\begin{matrix}maximize S ( x ; w ) = {\sum }_{i = 1}^{n} \vert {w}_{i} \vert {x}_{i} & ( Eq . 2 ) \\ \begin{matrix}subject to \text{:} {p}_{i} \geq {v}_{i} {ε}_{i} ( x ) , ∀ i \\ ε [ n ] , ( individual rationality ) \\ {\sum }_{i = 1}^{n} {p}_{i} \leq B ( budget feasibility ) \\ {x}_{i} ∈ \{ 0 , 1 \} , ∀ i ∈ [ n ] ( discrete estimator function ) \\ where , \\ {ε}_{i} ( x ) = \frac{Δ \vert {w}_{i} \vert {x}_{i}}{σ ( x )} = \frac{\vert {w}_{i} \vert {x}_{i}}{{\sum }_{i}^{ } \vert {w}_{i} \vert ( 1 - {x}_{i} )} ( canonical property ) .\end{matrix} & ( Eq . 3 )\end{matrix}$$

A mechanism Mₒₚₜ that outputs (xₒₚₜ,pₒₚₜ) will be an optimal, individually rational, budget feasible (but not necessarily truthful) DCLEF mechanism. Let OPT:=S(xₒₚₜ;w) be the optimal objective value of (Eq. 2). We use OPT as the benchmark to which we will compare the (truthful) mechanism we design below. Without loss of generality, we make the following assumption about the inputs to the mechanism.

Assumption 1. For all i ε [n], |wᵢ|vᵢ/(W−|wᵢ|)≦B.

Observe that if an individual i violates this assumption, then cᵢ(εᵢ(x))>B for any x output by a DCLEF mechanism that sets xᵢ=1. In other words, no DCLEF mechanism can compensate this individual within the analyst's budget; as a result, any budget-feasible DCLEF mechanism, and in particular Mₒₚₜ, will set xᵢ=0. Therefore, it suffices to focus on the subset of individuals for whom the assumption holds.

Observe that if the privacy guarantees were given by εᵢ(x)=xᵢ rather than (Eq. 3), (Eq. 2) would be identical to the budget-constrained mechanism design problem for knapsack studied by Singer (see supra). Under such εᵢ, Singer presents a truthful mechanism that is 6-approximate with respect to OPT. However, the privacy guarantees εᵢ(x) given by (Eq. 3) introduce externalities into the auction. In contrast to Singer, the εᵢ's couple the cost incurred by an individual i to the weight of other individuals that are compensated by the auction, making the mechanism design problem harder. This difficulty is overcome by our mechanism, which we call FairInnerProduct, described in ALGORITHM 1.

ALGORITHM 1 - FairInnerProduct (v, w, B)

```
$Let k be the largest integer such that \frac{B}{w ( [ k ] )} \geq \frac{{v}_{k}}{W - w ( [ k ] )} .$
Let i*: = argmax_{iε[n]} |wᵢ|.
Let \hat{p} be as defined in (Eq. 4).
if |wᵢ*| > Σ_{iε[k]\{i*}} |wᵢ| then
  Set 0 = {i*}.
  Set pᵢ* = \hat{p} and pᵢ = 0 for all i ≠ i*.
else
  Set 0 = [k].
  $Pay each i ∈ 0 , {p}_{i} = \vert {w}_{i} \vert min \{ \frac{B}{w ( [ k ] )} , \frac{{v}_{k + 1}}{W - w ( [ k ] )} \} ,$
  and for i ∉ 0,pᵢ = 0.
end if
Set xᵢ = 1 if i ε 0 and xᵢ = 0 otherwise.
```

The mechanism uses a greedy approach. Recall that vₗ≦ . . . ≦vₙ. The mechanism defines i*:=argmax_{iε[n]} |wᵢ|as the individual with the largest |wᵢ|, and k as the largest integer such that

$$\frac{B}{w ( [ k ] )} \geq \frac{{v}_{k}}{W - w ( [ k ] )} .$$

Subsequently, the mechanism either sets xᵢ=1 for the first k individuals, or, if |w_{i*}|>Σ_{iε[k]\(i*)}|wᵢ|, sets x_{i*}=1. In the former case, individuals i ε [k] are compensated in proportion to their absolute weights |wᵢ|. If, on the other hand, only x_{i*}=1, the individual i* receives a payment defined as follows: Let

$${S}_{- {i}^{*}} := \{ t ∈ [ n ] \backslash \{ {i}^{*} \} \text{:} \frac{B}{{\sum }_{i ∈ [ t ] \backslash \{ {i}^{*} \}}^{ } \vert {w}_{i} \vert} \geq \frac{{v}_{t}}{W - {\sum }_{i ∈ [ t ] \backslash \{ {i}^{*} \}}^{ } \vert {w}_{i} \vert} and {\sum }_{i ∈ [ t ] \backslash \{ {i}^{*} \}}^{ } \vert {w}_{i} \vert \geq \vert {w}_{{i}^{*}} \vert \} .$$

If S_{—i*}≠Ø, then let r:=min {i:i ε S_{—i*}}. Define

$$\hat{p} := \{ \begin{matrix}B , & if {S}_{- {i}^{*}} = ∅ \\ \frac{\vert {w}_{{i}^{*}} \vert {v}_{r}}{W - \vert {w}_{{i}^{*}} \vert} , & otherwise\end{matrix} \qquad ( Eq . 4 )$$

The next theorem states that FairInnerProduct has the properties we desire.

Theorem 1—FairInnerProduct is truthful, individually rational and budget feasible. It is 5-approximate with respect to OPT. Further, it is 2-approximate when all weights are equal.

We note that the truthfulness of the knapsack mechanism in Singer is established via Myerson's characterization of truthful single-parameter auctions by showing that the allocation is monotone and the payments are threshold. In contrast, because of the coupling of costs induced by the Laplace noise in DCLEFs, it is not possible to use Myerson's characterization and instead, give a direct argument about truthfulness.

We prove a 5-approximation by using the optimal solution of the fractional relaxation of (Eq. 2). This technique can also be used to show that the knapsack mechanism in Singer is 5-approximate instead of 6-approximate. FairInnerProduct generalizes the mechanism by Ghosh and Roth; in the special case when all weights are equal FairInnerProduct reduces to the Gosh and Roth mechanism, which, by Theorem 1, is 2-approximate with respect to OPT. In fact, Theorem 2 states that the approximation ratio of a truthful mechanism is lower-bounded by 2.

Theorem 2—(Hardness of Approximation) For all ε>0, there is no truthful, individually rational, budget feasible DCLEF mechanism that is also 2−ε—approximate with respect to OPT.

The above disclosed mechanisms allow a data analyzer in a setting in to buy private information—represented by a database d with entries dᵢ ε [symbol] i ε [n]—from a set of individuals in order to cheaply obtain an accurate estimate of the inner product of d with a publicly known weight vector w. We formalized the trade-off between privacy and accuracy in this setting; obtaining an accurate estimate necessitates giving poor privacy guarantees to individuals whose cumulative weight is large. DCLEF estimators achieve an order-optimal trade-off between privacy and accuracy, and, consequently, it suffices to focus on DCLEF mechanisms. We use this observation to design a truthful, individually rational, budget feasible mechanism under the constraint that the analyst has a fixed budget. Our mechanisms can be viewed as a proportional-purchase mechanisms, i.e., the privacy εᵢ guaranteed by the mechanism to individual i is proportional to weight |wᵢ|. The mechanism is 5-approximate in terms of accuracy compared to an optimal (possibly non-truthful) mechanism, and that no mechanism can achieve a 2−ε approximation, for any ε>0.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that provides statistical data, comprising:
a consumer electronic device that hosts a media application that gathers media content use data for a user, wherein the media application interfaces with a server that analyzes media content use-related data, wherein the server analyzes the data based on at least one of a budget-constrained DCLEF and a distortion-constrained DCLEF mechanism.

2. The system of claim 1, wherein the media application provides compensation for a user based on the user's media content use data sent to the server, wherein the compensation is based on the server's analysis.

3. The system of claim 1, wherein the consumer electronic device provides at least one of a wireless connection and a wired connection to the server via a wide area network (WAN).

4. The system of claim 1, wherein the server provides statistical media content use data to at least one consumer of the data.

5. The system of claim 4, wherein the consumer includes at least one of a media content creator, a media content retail store and a media content provider.

6. The system of claim 1, wherein the media application provides media content use data periodically.

7. The system of claim 1, wherein the media application provides media content use data after media content viewing by a user.

8. A method for providing media content use data, comprising:
extracting media content use data for a user on a consumer electronic device; and
sending the media content use data to a server via a wide area network (WAN) for analysis, wherein the server analyzes the media content use-related data based on at least one of a budget-constrained DCLEF and a distortion-constrained DCLEF mechanism.

9. The method of claim 8 further comprising:
compensating the user for the use data based on the server analysis.

10. The method of claim 8 further comprising:
sending the media content use data to the server via at least one of a wireless and a wired connection to a wide area network (WAN).

11. The method of claim 8 further comprising:
distributing from the server media content use data statistics to at least one consumer of media content use data.

12. The method of claim 11, wherein the consumer includes at least one of a media content creator, a media content retail store and a media content provider.

13. The method of claim 12 further comprising:
sending the media content use data periodically.

14. A system that analyzes media content use data, comprising:
a means for extracting media content use data for a user on a consumer electronic device; and
a means for sending the media content use data to a server via a wide area network (WAN) for analysis on a server, wherein the server analyzes the media content use-related data based on at least one of a budget-constrained DCLEF and a distortion-constrained DCLEF mechanism.

15. The system of claim 14 further comprising:
a means for compensating the user for the use data based on the server analysis.
